(19) United States
(12) Patent Application Publication
(10) Pub. No.: US 2024/0365146 A1
(43) Pub. Date: Oct. 31, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Rongyi HU, Dongguan (CN)

(21) Appl. No.: 18/769,023

(22) Filed: Jul. 10, 2024

Related U.S. Application Data
(63) Continuation of application No. PCT/CN2022/071668, filed on Jan. 12, 2022.

(51) Int. Cl. H04W 24/08

(52) U.S. Cl. CPC H04W 24/08

(57) ABSTRACT

A wireless communication method, a terminal device, and a network device are disclosed. The method includes: performing, by a terminal device, radio link monitoring (RLM) and beam detection according to a first measurement model, where the beam detection includes beam failure detection (BFD) and candidate beam detection (CBD).

### CROSS-REFERENCE TO RELATED APPLICATIONS

This application is a continuation of International Application No. PCT/CN2022/071668, filed on Jan. 12, 2022, the disclosure of which is hereby incorporated by reference in its entirety.

### TECHNICAL FIELD

Embodiments of this application relate to the communication field, and more specifically, to a wireless communication method, a terminal device, and a network device.

### BACKGROUND

In some scenarios, a terminal device may perform radio link monitoring (RLM) to determine whether radio link failure (RLF) occurs, and the terminal device may perform beam detection (BD) (including beam failure detection (BFD) and new beam identification (NBI)) mechanisms to determine whether to trigger beam failure recovery (BFR).

Procedures of RLM and BD are similar, but parameters used for measurement are different. How to perform RLM and BD to reduce complexity of the terminal device is a problem that needs to be resolved urgently.

### SUMMARY

This application provides a wireless communication method, a terminal device, and a network device. The terminal device may perform RLM and BD based on a uniform measurement model, to help to reduce complexity of the terminal device.

According to a first aspect, a wireless communication method is provided, including: performing, by a terminal device, radio link monitoring (RLM) and beam detection according to a first measurement model, where the beam detection includes beam failure detection (BFD) and candidate beam detection (CBD).

According to a second aspect, a wireless communication method is provided, including: transmitting, by a network device, first configuration information to a terminal device, where the first configuration information is used to configure a first measurement model and/or a model parameter of the first measurement model, the first measurement model is used by the terminal device to perform radio link monitoring (RLM) and beam detection, and the beam detection includes beam failure detection (BFD) and candidate beam detection (CBD).

According to a third aspect, a terminal device is provided and is configured to execute the method according to the first aspect or implementations of the first aspect.

Specifically, the terminal device includes a functional module configured to execute the method according to the first aspect or implementations of the first aspect.

According to a fourth aspect, a network device is provided and is configured to execute the method according to the second aspect or implementations of the second aspect.

Specifically, the network device includes a functional module configured to execute the method according to the second aspect or implementations of the second aspect.

According to a fifth aspect, a terminal device is provided, including a processor and a memory. The memory is configured to store a computer program, and the processor is configured to invoke and run the computer program stored in the memory, to execute the method according to the first aspect or implementations of the first aspect.

According to a sixth aspect, a network device is provided, including a processor and a memory. The memory is configured to store a computer program, and the processor is configured to invoke and run the computer program stored in the memory, to execute the method according to the second aspect or implementations of the second aspect.

According to a seventh aspect, a chip is provided and is configured to implement the method according to any one of the first aspect and the second aspect or implementations of the first aspect and the second aspect.

Specifically, the chip includes a processor, configured to invoke a computer program from a memory and run the computer program, to cause a device on which the apparatus is installed to execute the method according to any one of the first aspect and the second aspect or implementations of the first aspect and the second aspect.

According to an eighth aspect, a computer-readable storage medium is provided and configured to store a computer program. The computer program causes a computer to execute the method according to any one of the first aspect and the second aspect or implementations of the first aspect and the second aspect.

According to a ninth aspect, a computer program product is provided, including computer program instructions. The computer program instructions cause a computer to execute the method according to any one of the first aspect and the second aspect or implementations of the first aspect and the second aspect.

According to a tenth aspect, a computer program is provided, and when the computer program runs on a computer, the computer executes the method according to any one of the first aspect and the second aspect or implementations of the first aspect and the second aspect.

According to the foregoing technical solutions, a terminal device may perform RLM and BD based on a uniform measurement model, to help to reduce complexity of the terminal device.

### BRIEF DESCRIPTION OF DRAWINGS

FIG. 1 is a schematic diagram of an application scenario according to an embodiment of this application.

FIG. 2 is a schematic diagram of an RLM procedure in the related art.

FIG. 3 is a schematic diagram of a counting process of a higher layer of a terminal device in RLM.

FIG. 4 is a schematic diagram of a beam failure recovery procedure.

FIG. 5 is a schematic diagram of a wireless communication method according to an embodiment of this application.

FIG. 6 is a schematic diagram of a uniform measurement model.

FIG. 7 is a schematic block diagram of a terminal device according to an embodiment of this application.

FIG. 8 is a schematic block diagram of a network device according to an embodiment of this application.

FIG. 9 is a schematic block diagram of a communication device according to another embodiment of this application.

FIG. 10 is a schematic block diagram of a chip according to an embodiment of this application.

FIG. 11 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. For embodiments of this application, all other embodiments obtained by a person of ordinary skill in the art without creative efforts fall within the protection scope of this application.

The technical solutions in embodiments of this application may be applied to various communications systems, for example, a global system for mobile communication (GSM), a code division multiple access (CDMA) system, a wideband code division multiple access (WCDMA) system, general packet radio service (GPRS), a long term evolution (LTE) system, an advanced long term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunications system (UMTS), a wireless local area network (WLAN), wireless fidelity (Wi-Fi), a fifth-generation (5G) system, or another communications system.

Generally, a quantity of connections supported by a conventional communications system is limited and is also easy to implement. However, with development of communication technologies, a mobile communications system not only supports conventional communication, but also supports, for example, device-to-device (D2D) communication, machine to machine (M2M) communication, machine type communication (MTC), vehicle to vehicle (V2V) communication, or vehicle to everything (V2X) communication. Embodiments of this application may also be applied to these communications systems.

Optionally, a communications system in embodiments of this application may be applied to a carrier aggregation (CA) scenario, a dual connectivity (DC) scenario, or a standalone (SA) networking scenario.

Optionally, a communications system in embodiments of this application may be applied to an unlicensed spectrum, and the unlicensed spectrum may also be considered as a shared spectrum. Alternatively, a communications system in embodiments of this application may be applied to a licensed spectrum, and the licensed spectrum may also be considered as a non-shared spectrum.

Embodiments of this application are described with reference to a network device and a terminal device. The terminal device may also be referred to as user equipment (UE), an access terminal, a user unit, a user station, a mobile site, a mobile station, a remote station, a remote terminal, a mobile device, a user terminal, a terminal, a wireless communication device, a user agent, a user apparatus, or the like.

The terminal device may be a station (ST) in a WLAN, may be a cellular phone, a cordless phone, a session initiation system (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, or a terminal device in a future evolved public land mobile network (PLMN), or the like.

In embodiments of this application, the terminal device may be deployed on land, including being indoors or outdoors, may be handheld, wearable, or vehicle-mounted. The terminal device may be deployed on water (for example, on a ship), or may be deployed in the air (for example, on an airplane, an air balloon, or a satellite).

In embodiments of this application, the terminal device may be a mobile phone, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, or a wireless terminal device in smart home, or the like.

By way of example rather than limitation, in embodiments of this application, the terminal device may alternatively be a wearable device. The wearable device may also be referred in to as an intelligent wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, wearable smart devices may include a full-featured device, a large-sized device, and a device that can provide full or partial functions without relying on a smart phone, for example, a smart watch or smart glasses, and devices that only focus on a specific type of application function and need to cooperate with another device such as a smart phone for use, for example, various smart bracelets and smart jewelries for physical sign monitoring.

In embodiments of this application, the network device may be a device configured to communicate with a mobile device. The network device may be an access point (AP) in a WLAN, may be a base transceiver station (BTS) in GSM or CDMA, may be a NodeB (NB) in WCDMA, or may be an evolutional NodeB (eNB or eNodeB) in LTE, or a relay station or an access point, or a vehicle-mounted device, a wearable device, a network device or gNB in an NR network, or a network device in a future evolved PLMN, or a network device in an NTN, or the like.

By way of example rather than limitation, in embodiments of this application, the network device may have a mobility characteristic. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, or a high elliptical orbit (HEO) satellite. Optionally, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell. The small cell herein may include a metro cell, a micro cell, a pico cell, a femto cell, or the like. These small cells have a characteristic of a small coverage range and low transmit power, and are applicable to providing a high-rate data transmission service.

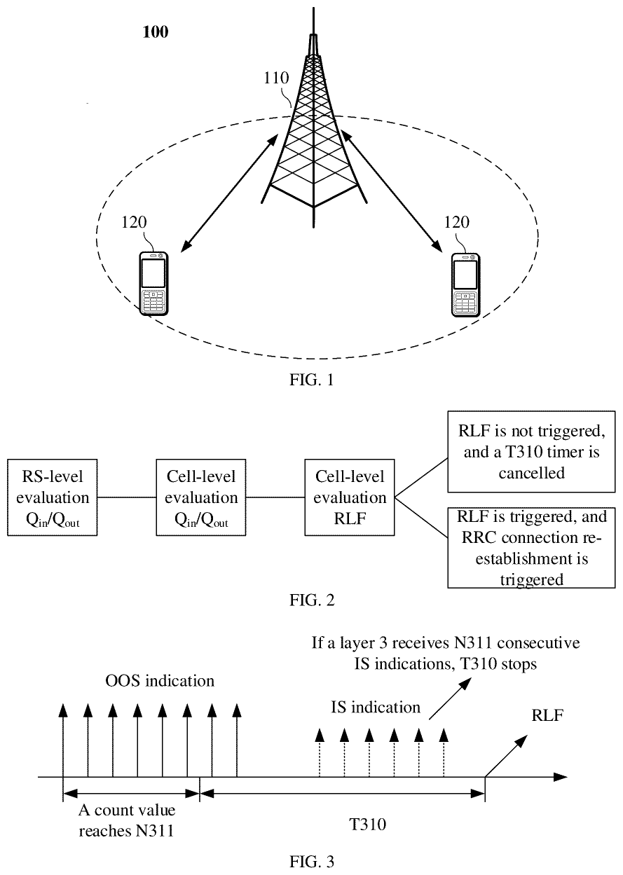

For example, FIG. 1 shows a communications system 100 to which embodiments of this application are applied. The communications system 100 may include a network device 110, and the network device 110 may be a device that communicates with a terminal device 120 (or referred to as a communication terminal or a terminal). The network device 110 may provide communication coverage for a specific geographic area, and may communicate with a terminal device within the coverage area.

FIG. 1 exemplarily shows one network device and two terminal devices. Optionally, the communications system 100 may include a plurality of network devices, and another quantity of terminal devices may be included in a coverage range of each network device, which is not limited in embodiments of this application.

Optionally, the communications system 100 may further include another network entity such as a network controller or a mobility management entity, which is not limited in embodiments of this application.

It should be understood that in embodiments of this application, a device having a communication function in a network/system may be referred to as a communication device. The communications system 100 shown in FIG. 1 is used as an example. The communication device may include the network device 110 and the terminal device 120 that have a communication function. The network device 110 and the terminal device 120 may be the foregoing specific devices, and details are not described herein again. The communication device may further include another device in the communications system 100, for example, another network entity such as a network controller or a mobility management entity, which is not limited in embodiments of this application.

It should be understood that the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” may be implemented by prestoring corresponding code or a corresponding table in a device (for example, including the terminal device and the network device) or in other manners that can be used for indicating related information, and a specific implementation thereof is not limited in this application. For example, the “predefining” may refer to being defined in a protocol.

In embodiments of this application, the “protocol” may be a standard protocol in the communication field, which may include, for example, an LTE protocol, an NR protocol, and a related protocol applied to a future communications system. This is not limited in this application.

Configuration information in embodiments of this application is sent by using at least one of the following signalling: a system message, physical layer signalling (for example, downlink control information (DCI)), radio resource control (RRC) signalling, or a medium access control control element (MAC CE).

To facilitate understanding of the technical solutions in embodiments of this application, a radio link monitoring (RLM) mechanism related to this application is described.

RLM is used to monitor and evaluate channel quality of a downlink of a serving cell, to generate an in-sync (IS) indication and an out-of-sync (OSS) indication.

In some embodiments, RLM includes but is not limited to measuring a radio link monitoring reference signal (RLM-RS) on a downlink bandwidth part (BWP), and the RLM-RS may include but is not limited to a synchronization signal block (SSB) or a channel state information reference signal (CSI-RS).

RLM may be applicable to a primary cell (PCell) or a primary secondary cell (PSCell), for example, primary cells in an SA NR mode, an NR-DC mode, and an NE-DC mode, or primary secondary cells in an NR-DC mode and an EN-DC mode.

In some embodiments, a network device may configure N radio link monitoring reference signals (RLM-RS) for a terminal device to perform radio link monitoring and evaluate radio link quality. The radio link quality is determined by using a hypothetical physical downlink control channel (PDCCH) block error rate (BLER).

In some embodiments, in an example in which the RLM-RS is an SSB, a measurement time (or a measurement evaluation time, an evaluation time, a measurement evaluation period, or an evaluation period) of the RLM may be in units of a period T_{SSB} of the SSB (a measurement gap is not configured). Optionally, within the measurement evaluation time, the terminal device may determine, according to a measurement result of the SSB, whether to report an IS indication or whether to report an OSS indication.

In some embodiments, for frequency range 1 (FR1), if the period of the SSB does not overlap a measurement gap period (MGRP), the measurement evaluation time does not need to be scaled. In this case, optionally, a measurement evaluation period of the OOS is 10*T_{SSB}, and a measurement evaluation period of the IS is 10*T_{SSB}. Otherwise, the measurement evaluation time is scaled, and a scaling factor is P=1/(1−T_{SSB}/MGRP) multiples.

In some embodiments, for FR2, because T_{SSB} may overlap a synchronization signal block measurement timing configuration (SMTC) period T_{SMTCperiod} or the MGRP, the measurement evaluation time needs to be scaled.

In some embodiments, the network device may configure an IS threshold Qᵢₙ and an OSS threshold Qₒᵤₜ. Qₒᵤₜ is defined as a level at which the downlink radio link cannot be reliably received, and Qᵢₙ is defined as a level at which the downlink radio link quality can be reliably received, where reception reliability of Qᵢₙ is significantly greater than that of Qₒᵤₜ.

In some embodiments, the IS threshold Qᵢₙ and the OSS threshold Qₒᵤₜ are represented by PDCCH BLERs. For example, Qᵢₙ is a PDCCH BLER 2%, and Qₒᵤₜ is a PDCCH BLER 10%.

In some embodiments, for RLM, a physical layer of the terminal device may execute the following operations:

For example, if signal quality of an RLM-RS is less than Qₒᵤₜ, the terminal device sends a layer 1 (L1) OSS indication to a higher layer (for example, a layer 3 (L3)) of the terminal device.

For example, if signal quality of an RLM-RS is greater than Qᵢₙ, the terminal device sends an L1 IS indication to a higher layer of the terminal device, for example, an L3. The IS indication and the OSS indication are collectively referred to as an L1 indication.

For example, the L3 of the terminal device performs L3 filtering on all indications (including the IS indication and the OSS indication) within the measurement evaluation period.

In some embodiments, the layer 1 may be a physical layer, and the layer 3 may be a radio resource control (RRC) layer.

In some embodiments, there is at least an interval T_{Indication_interval} between two consecutive L1 indications.

Optionally, T_{Indication_interval} may be max (10 ms, T_{RLM-RS,M}) or in a case that DRX is used, T_{Indication_interval} may be max (10 ms, 1.5*DRX cycle length (DRX_cycle_length), 1.5*T_{RLM-RS,M}), where T_{RLM-RS,M} is a minimum reference signal period of all RLM-RS resources of a monitored cell.

T_{RLM-RS,M} represents a period of an RLM-RS.

In some embodiments, the L3 filtering method may be configured based on RRC, or may be implemented based on a network. For example, the L3 filtering may be implemented based on a forward convolution averaging method.

With reference to FIG. 2, an overall procedure from the physical layer to the higher layer in RLM is described.

As shown in FIG. 2, the terminal device may measure a reference signal on each monitored cell to obtain a measurement result of each reference signal on the cell. Further, based on the measurement result of the reference signal, an evaluation result of the reference signal may be obtained, for example, IS or OOS. Then, an evaluation result of the cell is obtained according to evaluation results of all reference signals on the monitored cell. Further, it is determined, according to evaluation results of all cells, whether to trigger RLF. If it is determined not to trigger RLF, T310 timing is cancelled, or if RLF is to be triggered, RRC connection re-establishment is triggered.

With reference to FIG. 3, a counting operation of the higher layer of the terminal device in RLM is described.

1. The network device preconfigures an IS threshold and an OOS threshold for the terminal device, that is, Qᵢₙ and Qₒᵤₜ. The thresholds are given in a form of PDCCH BLERs.

2. The network device preconfigures an RLM measurement resource (including a reference signal resource) for the terminal device. The terminal device determines current channel quality by means of measurement on the given resource.

3. When the terminal device detects that quality of all RLM-RSs is less than the OOS threshold Qₒᵤₜ, the physical layer of the terminal device reports an L1 OOS indication to the higher layer of the terminal device.

4. When the terminal device detects that quality of at least one RLM-RS is greater than the IS threshold Qᵢₙ, the physical layer of the terminal device reports an L1 IS indication to the higher layer of the terminal device.

5. After detecting N310 (or referred to as an OSS counter) consecutive OOS indications are reported, the higher layer of the terminal device starts a timer T310 (or referred to as an RLF timer), and detects, within the T310 timer, whether N311 (or referred to as an IS counter) consecutive IS indications are reported. If yes, the timer T310 is stopped. If no, it is considered that a radio link failure (RLF) event occurs, and the RLF is reported and a subsequent procedure such as RRC connection re-establishment is triggered.

In some cases, when the terminal device determines to send the RLF event, a transmit radio frequency (Tx RF) unit needs to be disabled within 40 ms.

To facilitate understanding of the technical solutions in embodiments of this application, a beam detection (BD) mechanism in this application is described.

In some scenarios, a beam failure recovery (BFR) mechanism is designed for a primary cell (PCell) and a primary secondary cell (PSCell). The following steps are mainly included:
beam failure detection (BFD);
new beam identification (NBI) or candidate beam detection (CBD);
beam failure recovery request (BFRQ); and
monitoring, by the terminal device, a response of the network side to the BFRQ.

In some embodiments, the beam detection may include BFD and CBD.

For BFR, a physical layer of the terminal device measures a beam failure detection reference signal (BFD-RS), and determines, according to a measurement result, whether a beam failure event occurs. The BFD-RS may be a periodic CSI-RS or SSB. A determining condition may be as follows: If it is detected that link quality corresponding to all serving beams is very poor (for example, less than a threshold), it is determined that a beam failure instance (BFI) occurs, and the physical layer of the terminal device reports a BFI indication to a higher layer (for example, a medium access control (MAC) layer) of the terminal device. On the contrary, if the physical layer of the terminal device determines that the BFI does not occur, the physical layer of the terminal device does not send the BFI indication to the higher layer. The higher layer of the terminal device uses a counter (denoted as a BFD counter) and a timer (denoted as a BFD timer) to count BFI indications reported by the physical layer of the terminal device. Each time a BFI is received, the timer is restarted, and the counter performs recounting when the timer expires. When the counter reaches a maximum quantity of times configured by the network, the terminal device considers that a beam failure event occurs.

For NBI or CBD, the terminal device measures a set of candidate beams, and selects a beam that meets a specific threshold as a new beam. Then the terminal device notifies, through a beam failure recovery request procedure BFRQ, the network device that beam failure occurs, and reports the new beam. After receiving BFRQ information sent by the terminal device, the network device determines that beam failure occurs on the terminal, and sends a PDCCH on the new beam. When receiving the PDCCH sent by the network device on the new beam, the terminal device considers that response information on the network side is correctly received. In this case, the beam failure recovery procedure is successfully completed.

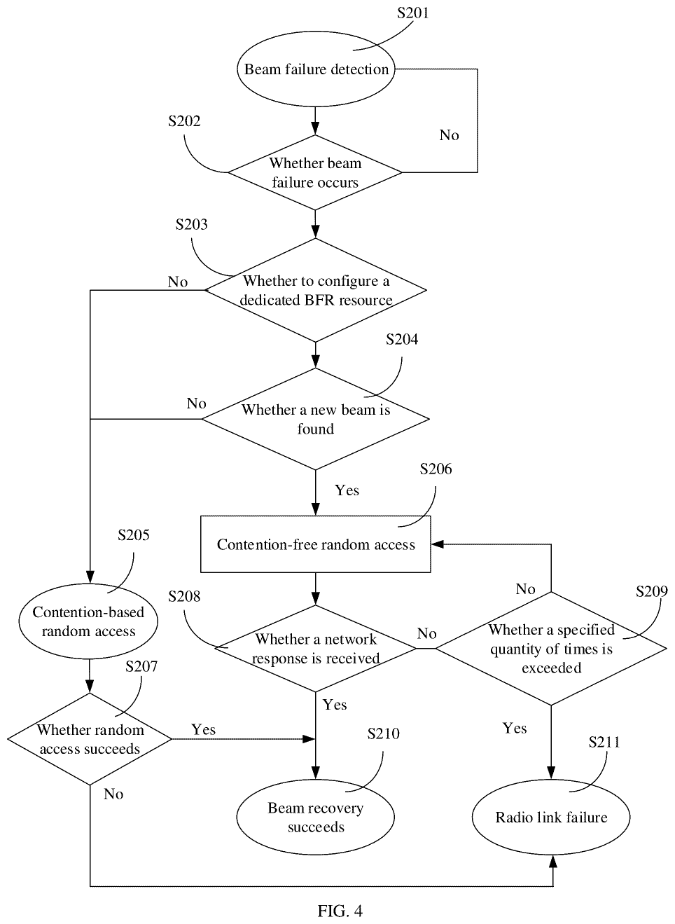

FIG. 4 is a schematic diagram of a beam failure recovery procedure related to this application. As shown in FIG. 4, the following steps may be included:

S201. Performing, by a terminal device, beam failure detection.

S202. Determining whether a beam failure event occurs.

If yes, S203 is performed; or if no, S201 is returned.

S203. Determining whether to configure a dedicated BFR resource.

If yes, S204 is performed; or if no, S205 is performed.

S204. Performing new beam identification to determine whether a new beam that meets a condition is selected.

If yes, S206 is performed; otherwise, S205 is performed.

S205. Initiating contention-free random access based on the new beam.

S206. Initiating contention-based random access.

S207. For contention-based random access, determining whether random access succeeds.

If yes, S210 is performed; otherwise, S211 is performed.

S208. For contention-free random access, determining whether a network response is received.

If yes, S210 is performed; otherwise, S209 is performed.

S209. Determining whether a quantity of times of initiating random access exceeds a specified quantity of times.

If yes, S211 is performed; otherwise, S206 is returned.

S210. Determining that beam recovery succeeds.

S211. Determining that radio link failure occurs.

In view of the above, the determining RLF may include the following two manners.

Manner 1: It is determined, according to the foregoing timer T310 and the counters N310 and N311, whether RLF occurs.

Manner 2: Beam detection fails, that is, BFD fails and CBD fails.

It can be learned from the foregoing RLM and BD procedures that both RLM and BD belong to L1 measurement. A measurement model mainly includes the following parameters:
an L1 measurement evaluation time, a reference signal configuration, an L1 reporting configuration (including a filter configuration, a counter configuration, and a timer configuration), and an event judgment criteria (including a threshold corresponding to an event).

1. L1 measurement evaluation time and reference signal configuration

Taking SSB-based RLM and BFD (for FR1, DRX is not configured) as an example:

1.1. Measurement evaluation time corresponding to RLM:
measurement evaluation time T_{Evaluate_out_SSB} (ms)=Max (200, Ceil (10×P)×T_{SSB}) used for reporting an OSS indication, where P represents a scaling factor, and Ceil represents rounding up; and
measurement evaluation time T_{Evaluate_in_SSB} (ms)=Max (100, Ceil (5×P)×T_{SSB}) used for reporting an IS indication, where P represents a scaling factor, and Ceil represents rounding up.
   1.2. Measurement evaluation time corresponding to Bfd:
measurement evaluation time T_{Evaluate_BFD_SSB}=Max (50, Ceil (5×P)×T_{SSB}) used for BFD, where P represents a scaling factor, and Ceil represents rounding up.

It can be learned from the above that a measurement evaluation period of RLM is greater than that of BFD, and execution of BFD is more frequent.

2. Time interval for reporting an L1 indication (or referred to as a reporting period of the L1 indication)

2.1. Reporting period corresponding to RLM.

For example, the reporting period T_{Indication_interval} may be max (10 ms, T_{RLM-RS,M}).

2.2. Reporting period corresponding to BFD.

The reporting period of BFD is T_{Indication_interval}=max (2 ms, T_{SSB-RS,M}) or max (2 ms, T_{CSI-RS,M}). T_{SSB-RS,M} is a minimum period of all SSB resources of a monitored cell, and T_{CSI-RS,M} is a minimum period of all CSI-RS resources of the monitored cell.

3. Event judgment criteria

3.1. Thresholds corresponding to RLM include the foregoing Qᵢₙ and Qₒᵤₜ.

For example, the terminal device determines, according to Qᵢₙ, whether to report IS, and determines, according to Qₒᵤₜ, whether to report OOS.

In RLM, determining of OOS is evaluated based on a hypothetical signal to interference plus noise ratio (SINR) of a PDCCH (for example, a threshold 10%), and the OOS indication is counted by a layer 3 of the terminal device. Only when measurement results of all reference signal resources (for example, CSI-RS resources) corresponding to a cell meet an OOS threshold, it can be determined that link failure occurs on the cell.

3.2. A threshold corresponding to BFD and a threshold corresponding to CBD are included. For BFD, the terminal device determines and evaluates BFD based on that a hypothetical signal to interference plus noise ratio (SINR) of a PDCCH is less than a threshold.

For example, the terminal device determines, according to the threshold corresponding to BFD, whether a beam failure instance occurs.

Candidate beam detection is used to find a new beam. CBD may be measuring layer 1-reference signal received power (L1-RSRP) to select a new beam, and a threshold of the RSRP may be determined by a medium access control (MAC) layer.

Therefore, procedures of RLM and BD are approximately the same, but parameters based on which measurement is performed are different. Therefore, how to perform RLM and BD to reduce complexity of the terminal device is a problem that needs to be resolved urgently.

In view of this, embodiments of this application provide a technical solution. Because both RLM and BD are measuring an L1 reference signal, and there is a high probability that a same reference signal configuration is used for measurement, a uniform measurement model is used for measurement in RLM and BD, to help to reduce complexity of the terminal device.

To facilitate understanding of the technical solutions in embodiments of this application, the following describes the technical solutions in this application in detail by using specific embodiments. The foregoing related technologies, as optional solutions, may be randomly combined with the technical solutions of embodiments of this application, all of which fall within the protection scope of embodiments of this application. Embodiments of this application include at least a part of the following content.

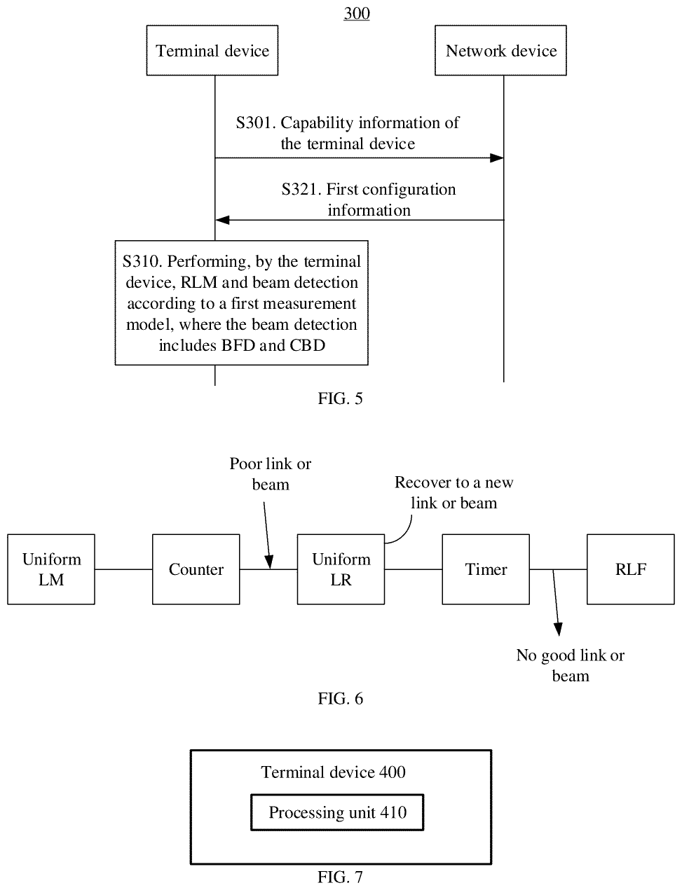

FIG. 5 is a schematic diagram of interaction of a wireless communication method 300 according to an embodiment of this application. As shown in FIG. 5, the method 300 includes the following content:

S310. Performing, by a terminal device, radio link monitoring RLM and beam detection according to a first measurement model, where the beam detection includes beam failure detection BFD and candidate beam detection CBD.

Therefore, the terminal device may perform RLM and beam detection based on a uniform measurement model, to help to reduce complexity of the terminal device.

It should be noted that in embodiments of this application, that the terminal device performs RLM and beam detection based on a uniform measurement model may mean that model structures for performing RLM and beam detection by the terminal device are the same, or procedures of performing RLM and beam detection are the same.

It should be understood that, in embodiments of this application, a beam may be replaced with a reference signal. Correspondingly, beam detection may also be represented as reference signal detection, beam failure detection may also be represented as reference signal failure detection, and candidate beam detection may also be represented as candidate reference signal detection.

In some embodiments, the first measurement model may include the following parts:
layer 1 measurement, reporting of a layer 1 indication, and event judgment based on the reported layer 1 indication.

In some embodiments, for RLM, the layer 1 measurement may be measurement on a reference signal used for RLM, or measurement on a beam used for RLM.

In some embodiments, for RLM, the layer 1 indication may include an OOS indication and/or an IS indication.

In some embodiments, for BFD, the layer 1 measurement may be measurement on a reference signal used for BFD, or measurement on a beam used for BFD.

In some embodiments, for BFD, the layer 1 indication may include a beam failure instance BFI indication.

In some embodiments, the OOS indication corresponding to RLM and the BFI indication corresponding to BFD may use a uniform model parameter, for example, a uniform determining threshold, and/or a uniform counter threshold.

In some embodiments, for CBD, the layer 1 measurement may be measurement on a reference signal used for CBD, or measurement on a beam used for CBD, to select a new beam.

In some embodiments, a uniform model parameter may be used for IS evaluation corresponding to RLM and new beam identification in CBD. For example, a uniform determining threshold, and/or a uniform counter threshold may be used for IS determining and new beam identification.

In some embodiments, a reference signal configuration used for RLM and a reference signal configuration used for BFD may be a same configuration. In this way, RLM and BFD may be uniformly measured, to help to reduce complexity of the terminal device.

For example, a reference signal configuration used for RLM and BFD may configure a set of reference signals with better signal quality (being determined according to historical data), so that when the quality of these reference signals becomes worse, it may be considered that radio link failure or beam failure occurs.

For another example, a reference signal configuration used for RLM and BFD may configure reference signals on a PCell and a PSCell.

In some embodiments, for RLM, the event judgment based on the reported layer 1 indication may include:
determining, according to an OOS indication reported by a physical layer of the terminal device, whether to trigger RLF; or
determining, according to an OOS indication and an IS indication reported by a physical layer of the terminal device, whether to trigger RLF.

In an example, when a quantity of reported OOS indications reaches a counter threshold, it is considered that an RLF event occurs, or RLF is triggered according to the OOS indication and the IS indication reported by the physical layer. For example, after a higher layer of the terminal device detects that N310 consecutive OOS indications are reported, a timer is started, and within the timer, it is detected whether N311 consecutive IS indications are reported. If yes, the timer is stopped, or if no, it is considered that an RLF event occurs.

In some embodiments, for BFD, the event judgment based on the reported layer 1 indication may include:
determining, according to a BFI indication reported by a physical layer of the terminal device, whether beam failure occurs.

For example, when a quantity of BFI indications reported by the physical layer of the terminal device reaches a counter threshold, it is determined that beam failure occurs.

With reference to specific embodiments, the following describes a uniform RLM and beam detection method, or a link failure and beam failure evaluation method.

### Embodiment 1

In some embodiments of this application, S310 may include:
performing RLM according to the first measurement model and a first model parameter; and
performing beam detection according to the first measurement model and a second model parameter, where
the first model parameter is at least partially different from the second model parameter.

That is, the terminal device may perform RLM and beam detection based on a same measurement model and differentiated model parameters.

Optionally, the differentiated model parameters may be determined according to measurement requirements of RLM and beam detection.

In some embodiments, the first model parameter includes at least one of the following:
first measurement evaluation time information, a first reference signal configuration, a first filter configuration, a first timer configuration, a first counter configuration, a first reporting time interval, or a first threshold configuration.

In some embodiments, the first measurement evaluation time information may be a time for which the terminal device performs measurement evaluation on a reference signal used for RLM.

In some embodiments, the first reference signal configuration is used to configure the reference signal for performing RLM by the terminal device.

Optionally, the first reference signal configuration is used to configure reference signals on a PCell and a PSCell.

In some embodiments, the first filter configuration is used to configure a parameter for filtering a measurement result of RLM by the terminal device.

Optionally, the first filter configuration is used to configure a filter configuration for filtering a measurement result of an RLM-RS by a layer 1 of the terminal device, and/or a filter configuration for filtering, by a layer 3 of the terminal device, a layer 1 indication reported by the layer 1 of the terminal device.

In some embodiments, a measurement result of a reference signal may be a signal to interference plus noise ratio (SINR), or may be another measurement result, for example, reference signal receiving power (RSRP) or reference signal receiving quality (RSRQ).

In some embodiments, the first timer configuration is used to configure a timing threshold for triggering RLF by the terminal device.

Optionally, the first timer configuration may include a timer configuration of an RLF timer (for example, T310). For a function of the T310 timer, refer to the related description of the foregoing embodiment. Details are not described herein again.

In some embodiments, the first counter configuration is used to configure a count value threshold for triggering RLF by the terminal device.

Optionally, the first counter configuration may include a configuration of an OSS counter (that is, N310) and/or an IS counter (that is, N311). For functions of N310 and N311, refer to the related description of the foregoing embodiment. Details are not described herein again.

In some embodiments, the first reporting time interval is used to configure a minimum time interval at which a physical layer of the terminal device reports a layer 1 indication to a higher layer of the terminal device, and corresponds to the above T_{Indication_interval}.

In some embodiments, the first threshold configuration is used to configure a determining threshold of an RLF event and/or a determining threshold of the layer 1 indication.

Optionally, the determining threshold of the RLF event may also include the configuration of N311.

Optionally, the determining threshold of the layer 1 indication may include a threshold corresponding to an IS indication and a threshold corresponding to an OOS indication, which are respectively corresponding to Qᵢₙ and Qₒᵤₜ in the foregoing embodiment. Optionally, Qᵢₙ and Qₒᵤₜ are represented by PDCCH BLERS.

In some embodiments, when comparison is performed, the measurement result of the reference signal is mapped to a hypothetical PDCCH BLER, and the mapped hypothetical PDCCH BLER is further compared with Qᵢₙ and Qₒᵤₜ to determine whether to report the IS indication or the OOS indication.

In some embodiments, the second model parameter includes at least one of the following:
second measurement evaluation time information, a second reference signal configuration, a second filter configuration, a second timer configuration, a second counter configuration, a second reporting time interval, or a second threshold configuration.

In some embodiments, the second measurement evaluation time information may include:
a time for which the terminal device performs measurement evaluation on a reference signal or beam used for BFD, and
a time for which the terminal device performs measurement evaluation on a reference signal or beam used for CBD.

In some embodiments, the second reference signal configuration is used to configure at least one of the following:
a reference signal for performing BFD by the terminal device; or
a reference signal for performing CBD by the terminal device.

Optionally, the second reference signal configuration is used to configure reference signals on a PCell and a PSCell.

It should be understood that, in embodiments of this application, a reference signal configuration (for example, the first reference signal configuration, the second reference signal configuration, or a third reference signal configuration below) may be used to configure but is not limited to at least one of the following parameters: a bandwidth, a subcarrier spacing (SCS), a cyclic prefix (CP), a center frequency, a period, or a length.

In some embodiments, the second filter configuration is used to configure a parameter for filtering a measurement result of BFD and/or a measurement result of CBD by the terminal device.

In some embodiments, the second timer configuration is used to configure a timing threshold for triggering BFR by the terminal device.

Optionally, the second timer configuration is used to configure a timing value of the foregoing BFD timer. During running of the BFD timer, a higher layer of the terminal device determines whether a BFI indication reported by a physical layer of the terminal device is received, and if the BFI indication is received, the BFD timer is restarted.

In some embodiments, the second counter configuration is used to configure a count value threshold for triggering BFR by the terminal device.

Optionally, the second counter configuration is used to configure a count value threshold of the foregoing BFD counter. For example, when the higher layer of the terminal device receives the BFI indication, a count value of the BFD counter is increased by one, and when the count value exceeds the count value threshold, it is determined that a beam failure event occurs.

In some embodiments, the second reporting time interval is used to configure a minimum time interval at which a physical layer of the terminal device reports a beam failure instance BFI to a higher layer of the terminal device.

In some embodiments, the second threshold configuration is used to configure a determining threshold of the BFI (denoted as a BFI threshold) and/or a determining threshold of a new beam (denoted as an NBI threshold).

For example, when a measurement result of the reference signal used for BFD is less than the BFI threshold, it is determined to send a BFI indication.

For another example, when a measurement result of the reference signal used for CBD is greater than the NBI threshold, a new beam is determined.

Optionally, the BFI threshold may be an SINR threshold, or may be another signal quality threshold, for example, an RSRP threshold or an RSRQ threshold.

Optionally, the NBI threshold may be an RSRP threshold, or may be another signal quality threshold, for example, an SINR threshold or an RSRQ threshold.

In some other embodiments, the BFI threshold and the NBI threshold may also be represented by PDCCH BLERs. When comparison is performed, the measurement result of the reference signal is mapped to a hypothetical PDCCH BLER, and the mapped hypothetical PDCCH BLER is further compared with the BFI threshold and the NBI threshold.

In some embodiments, that the first model parameter is different from the second model parameter may include at least one of the following:
the first measurement evaluation time information is different from the second measurement evaluation time information;
the first reference signal configuration is different from the second reference signal configuration;
the first filter configuration is different from the second filter configuration;
the first timer configuration is different from the second timer configuration;
the first counter configuration is different from the second counter configuration;
the first reporting time interval is different from the second reporting time interval; or
the first threshold configuration is different from the second threshold configuration.

Optionally, that the first reference signal configuration is different from the second reference signal configuration may include:
the first reference signal configuration includes a reference signal configuration used for RLM such as q2, and the second reference signal configuration includes a reference signal configuration used for BFD such as q0 and a reference signal configuration used for CBD such as q1, where the terminal device performs RLM based on q2, performs BFD based on q0, and performs CBD based on q1.

In some embodiments, the first reference signal configuration is the same as the second reference signal configuration. That is, a reference signal or beam configuration used for performing BFD and a reference signal or beam configuration used for performing CBD are a same configuration. That is, BFD, CBD, and RLM are performed by using a uniform reference signal configuration. For example, the reference signal configuration is used to configure a specific reference signal set. Optionally, the specific reference signal set may be determined according to a historical measurement result and/or a use status of a reference signal. For example, the specific reference signal set may be a reference signal set with better signal quality in history, or a frequently used reference signal set. Optionally, the specific reference signal set may be a set of reference signals with a specific characteristic (or representative reference signals), for example, a set of reference signals with a spatial random distribution or typical distribution characteristic. In other words, measurement is performed based on these reference signals, to facilitate that link quality or beam quality can be accurately determined.

In some embodiments, that the first counter configuration is different from the second counter configuration may include:
a count value threshold corresponding to an OSS counter (for example, N310) is different from a count value threshold corresponding to a BFD counter.

In some embodiments, that the first threshold configuration is different from the second threshold configuration may include:
a determining threshold for reporting a layer 1 indication for RLM by the terminal device is different from a determining threshold for reporting a layer 1 indication for BFD.

For example, the first threshold configuration is used to configure Qᵢₙ and Qₒᵤₜ, and the second threshold configuration is used to configure a BFD threshold and a CBD threshold, where Qᵢₙ is different from the CBD threshold and/or Qₒᵤₜ is different from the BFD threshold.

Optionally, the foregoing thresholds may be represented by PDCCH BLERs. For example, Qₒᵤₜ is 10%, the BFD threshold is 9%, Qᵢₙ is 2%, and the CBD threshold is 1%. When a measurement result of a reference signal is compared with a threshold, the measurement result may be mapped to a PDCCH BLER according to a mapping relationship between the measurement result and the PDCCH BLER, and then comparison is performed.

In some embodiments, the first measurement evaluation time information is the same as the second measurement evaluation time information.

That is, a time for which the terminal device performs layer 1 measurement of RLM is the same as a time for which the terminal device performs layer 1 measurement of beam detection.

In some embodiments, the second measurement evaluation time information includes first duration information and second duration information, where the first duration information is a measurement evaluation time for which the terminal device performs BFD, and the second duration information is a measurement evaluation time for which the terminal device performs CBD.

In some embodiments, the first measurement evaluation time information is determined according to first duration information and second duration information.

For example, the first measurement evaluation time information is a sum of the first duration information and the second duration information.

That is, a total measurement evaluation time for which the terminal device performs BFD and CBD is determined as a measurement evaluation time of RLM.

In some embodiments of this application, the first duration information is determined according to the following formula:

T_{Evaluate_BFD}=MAX(X,M1*K_{BFD}*N1*T_{BED_RS}),
where T_{Evaluate_BFD} represents the first duration information, X represents a measurement evaluation time threshold corresponding to BFD, M1 represents a quantity of measurement samples corresponding to BFD, K_{BFD} represents a scaling factor corresponding to BFD, N1 represents a quantity of reference signals or beams configured for BFD, and T_{BFD_RS} represents a reference signal period used for BFD.

In some embodiments, X is determined according to a capability of the terminal device.

For example, the terminal device may report capability information to a network device, and the network device may evaluate, by using the capability information reported by the terminal device, a time required for performing BFD by the terminal device, to obtain X.

In some embodiments, X is 50 ms.

In some embodiments, M1 represents a quantity of measurement samples corresponding to BFD, or is a quantity of measurement times used to obtain an evaluation result (for example, IS or OOS). Optionally, M1 may be 10, or may be another integer value greater than 1.

In some embodiments, M1 may be considered as a quantity of measurement times in a link monitoring (LM) phase, and therefore M1 is referred to as M_{LM}.

In some embodiments, K_{BFD} represents a scaling factor corresponding to BFD.

Optionally, K_{BFD} is related to P1 and/or P_{BFD}, where P1 represents a scaling factor caused by a conflict between performing BFD and other measurement or a measurement gap, and P_{BFD} represents a cell-related scaling factor in BFD. For example, K_{BFD}=P1*P_{BFD}.

Optionally, when there is no conflict between BFD and other measurement or a measurement gap, P1 may be 1.

Optionally, N1 may be a quantity of reference signals or beams used for BFD on one cell.

Optionally, T_{BFD_RS} may be an SSB period T_{SSB-RS} or a CSI-RS period T_{CSI-RS} used for BFD.

In some embodiments of this application, the second duration information is determined according to the following formula:

T_{Evaluate_CBD}=MAX(Y,M2*K_{CBD}*N2*T_{CBD_RS}),
where T_{Evaluate_BD} represents the second duration information, Y represents a measurement evaluation time threshold corresponding to CBD, M2 represents a quantity of measurement samples corresponding to CBD, K_{CBD} represents a scaling factor corresponding to CBD, N2 represents a quantity of reference signals or beams configured for CBD, and T_{CBD_RS} represents a reference signal period used for CBD. In some embodiments, Y is determined according to a capability of the terminal device.

For example, the terminal device may report capability information to a network device, and the network device may evaluate, by using the capability information reported by the terminal device, a time required for performing CBD by the terminal device, to obtain Y.

In some embodiments, Y is 25 ms.

In some embodiments, M2 represents a quantity of measurement samples corresponding to CBD, or a quantity of measurement times used to obtain an evaluation result (for example, whether a BFI occurs). Optionally, M2 may be 3, or may be another integer value greater than 1.

In some embodiments, M2 may be considered as a quantity of measurement times in a link recover (LR) phase, and therefore M2 is referred to as M_{LR}.

In some embodiments, K_{CBD} represents a scaling factor corresponding to CBD.

Optionally, K_{CBD} is related to P2 and/or P_{CBD}, where P2 represents a scaling factor caused by a conflict between performing CBD and other measurement or a measurement gap, and P_{CBD} represents a cell-related scaling factor in CBD. For example, K_{CBD}=P2*P_{CBD}.

Optionally, when there is no conflict between CBD and other measurement or a measurement gap, P2 may be 1.

Optionally, T_{CBD_RS} may be an SSB period T_{SSB-RS} or a CSI-RS period T_{CSI-RS} used for CBD.

Optionally, N2 may be a quantity of reference signals or beams used for CBD on one cell.

Optionally, N2 may be 1.

In some embodiments, the first measurement evaluation time information is determined according to the following formula:

T_{Evaluate_RLM}=MAX(X,M1*K_{BFD}*N1*T_{BFD_RS})+MAX(Y,M2*K_{CBD}*N2*T_{CBD_RS}),
where T_{Evaluate_RLM} represents the first measurement evaluation time information. For meanings of other parameters, refer to the description of the corresponding parameters in the first duration information and the second duration information. For brevity, details are not described herein again.

Table 1 shows a change in a measurement evaluation time for RLM before and after use of a uniform measurement model.

TABLE 1

| | Measurement evaluation time in the |
|---|---|
| RLM | uniform measurement model |
| Max(200, | MAX(50, |
| Ceil(Mₒᵤₜ*P)*T_{RLM}_{_{—}}_{RS}) = | M1*P1*P_{CBD}*N1*T_{BFD}_{_{—}}_{RS}) + MAX(25, |
| 800 ms | M2*P_{CBD}*N2*T_{CBD}_{_{—}}_{RS}) = 520 ms |

In view of the above, radio link failure and beam failure measurement evaluations are performed based on the uniform measurement model, so that complexity of L1 sampling is reduced and a time for RLM is shortened, thereby reducing complexity of the terminal device. In addition, differentiated model parameters, for example, two sets of counter configurations and timer configurations, are used to avoid a problem that some beams are not monitored because a reference signal set configured for measurement is not representative, or a problem that not very poor link quality is misjudged as a link failure of a cell.

### Embodiment 2

In some other embodiments of this application, S310 may include:
performing RLM according to the first measurement model and a third model parameter; and
performing beam detection according to the first measurement model and the third model parameter.

That is, the terminal device may perform RLM and beam detection based on a same measurement model and a same model parameter.

In some embodiments, the third model parameter includes at least one of the following: third measurement evaluation time information, a third reference signal configuration, a third filter configuration, a third timer configuration, a third counter configuration, a third reporting time interval, or a third threshold configuration.

In some embodiments, a reference signal configured by the third reference signal configuration is used by the terminal device to perform RLM and beam detection.

Optionally, the third reference signal configuration does not distinguish between BFD and CBD, that is, a reference signal configuration used for performing BFD and a reference signal configuration used for performing CBD are a same configuration. In other words, the third reference signal configuration is used for BFD, CBD, and RLM.

In some embodiments, the third reference signal configuration is used to configure a set of specific reference signals, and the specific reference signals have a spatial random distribution or typical distribution characteristic. In other words, measurement is performed based on these reference signals, to facilitate that link quality or beam quality can be accurately determined.

In some embodiments, the third reference signal configuration may be determined according to a historical measurement result and/or a use status of a reference signal. For example, the third reference signal configuration may be used to configure a set of reference signals with better signal quality in history, or a set of frequently used reference signals.

In some embodiments, a filtering parameter configured by the third filter configuration is used by the terminal device to filter a measurement result of RLM, a measurement result of BFD, and a measurement result of CBD.

In some embodiments, a timing threshold configured by the third timer configuration is used by the terminal device to trigger RLF and BFR.

For example, the timing threshold configured by the third timer configuration may be used for timing of the foregoing BLF timer and BFD timer.

In some embodiments, a count value threshold configured by the third counter configuration is used by the terminal device to trigger RLF and is used by the terminal device to trigger BFR.

For example, the count value threshold configured by the third counter configuration may be count value thresholds of the foregoing OSS counter and BFD counter.

In some embodiments, a time interval threshold configured by the third reporting time interval is used by a physical layer of the terminal device to report a layer 1 indication for RLM, and is also used by the physical layer of the terminal device to report a layer 1 indication for BFD.

That is, a minimum time interval at which the terminal device reports the layer 1 indication for RLM is the same as a minimum time interval at which the terminal device reports the layer 1 indication for BFD.

In some embodiments, a threshold configured by the third threshold configuration is used to determine whether to trigger an RLF event and/or report the layer 1 indication.

In some embodiments, the third threshold configuration is used to configure a first determining threshold and a second determining threshold. The first determining threshold is used to determine whether to report an OOS indication and whether a BFI occurs, and the second determining threshold is used to determine whether to report an IS indication and whether a new beam is used. Optionally, the foregoing thresholds may be represented by PDCCH BLERs. For example, the first determining threshold is 10%, and the second determining threshold is 2%. When a measurement result of a reference signal (for example, an SINR) is compared with a threshold, the measurement result may be mapped to a PDCCH BLER according to a mapping relationship between the measurement result and the PDCCH BLER, and then comparison is performed.

In some embodiments, the third measurement evaluation time information is used by the terminal device to perform layer 1 measurement for RLM and layer 1 measurement for BFD and CBD.

That is, a measurement evaluation time for which the terminal device performs layer 1 measurement for RLM is the same as a measurement evaluation time for which the terminal device performs layer 1 measurement for BFD and CBD.

In some embodiments, the third measurement evaluation time information is a sum of first duration information and second duration information, where the first duration information is a measurement evaluation time for which the terminal device performs BFD, and the second duration information is a measurement evaluation time for which the terminal device performs CBD.

In some embodiments, the third measurement evaluation time information is determined according to the following formula:

$${T}_{Evaluate \_ RLM} = MAX ( X , M 1 * {K}_{BFD} * N 1 * {T}_{BFD \_ RS} ) + MAX ( Y , M 2 * {K}_{CBD} * N 2 * {T}_{CBD\_RS} ) ,$$

where T_{Evaluate_RLM} represents the third measurement evaluation time information, X represents a measurement evaluation time threshold corresponding to BFD, M1 represents a quantity of measurement samples corresponding to BFD, K_{BFD} represents a scaling factor corresponding to BFD, N1 represents a quantity of reference signals or beams configured for BFD, T_{BFD_RS} represents a reference signal period used for BFD, Y represents a measurement evaluation time threshold corresponding to CBD, M2 represents a quantity of measurement samples corresponding to CBD, K_{CBD} represents a scaling factor corresponding to CBD, N2 represents a quantity of reference signals or beams configured for CBD, and T_{CBD_RS} represents a reference signal period used for CBD.

For meanings of the foregoing parameters, refer to the related description of the foregoing embodiment. For brevity, details are not described herein again.

In some embodiments of this application, as shown in FIG. 5, the method 300 further includes:

S321. Receiving, by the terminal device, first configuration information sent by a network device, where the first configuration information is used to configure the first measurement model and/or a model parameter of the first measurement model.

Optionally, the model parameter of the first measurement model may include the foregoing first model parameter and second model parameter, or may include the third model parameter.

In some embodiments of this application, as shown in FIG. 5, the method 300 further includes:

S301. Reporting, by the terminal device, capability information of the terminal device to a network device, where the capability information of the terminal device is used by the network device to determine a model parameter of the first measurement model.

It should be understood that the capability information of the terminal device may be measurement-related capability information of the terminal device, which is not limited in this application.

In an example, the capability information of the terminal device may include but is not limited to at least one of the following:
a maximum quantity of reference signals or beams supported by the terminal device;
a maximum frequency layer that is supported by the terminal device and that is used for reference signal or beam measurement; or
a maximum quantity of reference signals or beams or cells supported by the terminal device at each frequency layer.

For example, the network device may determine the first model parameter and the second model parameter according to the capability information of the terminal device, or determine the third model parameter according to the capability information of the terminal device.

In view of the above, radio link failure and beam failure measurement evaluations are performed based on the uniform measurement model, so that complexity of L1 sampling is reduced and a time for RLM is shortened, thereby reducing complexity of the terminal device.

In some embodiments, the network device may design, according to capability information reported by a plurality of terminal devices, a measurement model and a model parameter that are applicable to the plurality of terminal devices. Further, the measurement model and the model parameter are configured for the plurality of terminal devices.

In some other embodiments, the network device may design, according to the capability information of the plurality of terminal devices, a measurement model and a model parameter that are applicable to some terminal devices, for example, a measurement model and a model parameter that are applicable to terminal devices with a stronger processing capability. Further, the measurement model and the model parameter are configured for these terminal devices. Other terminal devices may perform RLM and beam detection by using an independent measurement model, that is, perform RLM and beam detection in an existing manner.

With reference to FIG. 6, the method for performing RLM and beam detection by using the uniform measurement model in embodiments of this application is described.

In an implementation:

First, layer 1 measurement is performed based on a uniform link monitoring (LM) model.

For example, RLM and beam detection are performed based on same measurement evaluation time information.

For another example, RLM and beam detection are performed based on a same reference signal configuration.

For another example, whether to report a layer 1 indication is determined based on a same threshold (including a threshold 1).

In an example, for RLM, when quality of a reference signal is less than the threshold 1 (corresponding to Qₒᵤₜ in the foregoing embodiment), an OOS indication is reported.

In an example, for BFD, when quality of a reference signal is less than the threshold 1, a BFI indication is reported.

Further, event judgment is performed based on a same count value threshold.

For example, when a quantity of layer 1 indications reported by the physical layer of the terminal device reaches a count value threshold, it may be considered that link quality or beam quality is poor.

Link recovery or beam recovery is further performed based on a uniform link recover (LR) model. In some embodiments, for beam detection, the terminal device performs CBD to select a new beam.

In some embodiments, for RLM, the terminal device continues to measure another reference signal used for RLM, that is, detect a new link, to determine whether there is a link with good quality.

In some embodiments, a reference signal configuration used for RLM and beam detection is used to configure a reference signal set 1 and a reference signal set 2. For example, in the uniform LM model, the terminal device may perform RLM and BFD based on the reference signal set 1.

Further, in the uniform LR model, for beam detection, the terminal device may measure the reference signal set 2 to select a new beam. For RLM, the terminal device may continue to measure reference signals in the reference signal set 2 to determine link quality corresponding to these reference signals.

Further, if the terminal device finds no new beam or no link with good quality during running of a timer, RLF is triggered.

That is, if BFD fails and CBD fails, RLF is determined; or if link quality corresponding to all reference signals in the reference signal configuration does not meet the foregoing threshold 1, RLF is determined.

In another implementation:

First, layer 1 measurement is performed based on a uniform LM model.

For example, RLM and beam detection are performed based on same measurement evaluation time information.

For another example, RLM and beam detection are performed based on a same reference signal configuration.

For another example, it is determined, based on a same threshold (including a threshold 1 and optionally, a threshold 2), whether to report a layer 1 indication.

In an example, for RLM, when quality of a reference signal is less than the threshold 1 (corresponding to Qₒᵤₜ in the foregoing embodiment), an OOS indication is reported.

Optionally, for RLM, when quality of a reference signal is greater than the threshold 2 (corresponding to Qᵢₙ in the foregoing embodiment), an IS indication is reported.

In an example, for BFD, when quality of a reference signal is less than the threshold 1, a BFI indication is reported.

In some embodiments, a reference signal configuration used for RLM and beam detection is used to configure a reference signal set 1 and a reference signal set 2. For example, in the uniform LM model, the terminal device may perform RLM and BFD based on the reference signal set 1.

Further, optionally, event judgment is performed based on a same count value threshold.

For example, when a quantity of layer 1 indications reported by the physical layer of the terminal device reaches a count value threshold, it may be considered that link quality or beam quality is poor.

In some embodiments, for RLM, RLF may be triggered when link quality or beam quality corresponding to all reference signals in the reference signal set 1 is not good.

In some embodiments, for BFD, CBD may be triggered when link quality or beam quality corresponding to all reference signals in the reference signal set 2 is not good.

Link recovery or beam recovery is further performed based on a uniform LR model.

In some embodiments, for beam detection, the terminal device performs CBD. For example, the terminal device measures a reference signal in the reference signal set 2 to select a new beam and initiates a random access procedure based on the selected new beam.

In some embodiments, for RLM, the terminal device initiates a random access procedure based on a reference signal in the reference signal set 2 or initiates a random access procedure on a cell corresponding to a reference signal in the reference signal set 2.

Further, the terminal device monitors a response of the network device, and if the response of the network device is received, determines that beam failure recovery succeeds, or that link recovery succeeds. If no response from the network device is received, a random access procedure is re-initiated by using another reference signal or beam.

In the embodiments of this application, a terminal device may perform RLM and beam detection based on a uniform measurement model. For example, RLM and beam detection are performed based on a uniform measurement model and a uniform model parameter, to facilitate that complexity of L1 sampling is reduced and a time for RLM is shortened, thereby reducing complexity of the terminal device. For another example, RLM and beam detection are performed based on a uniform measurement model and differentiated model parameters, to facilitate that complexity of L1 sampling is reduced and a time for RLM is shortened, thereby reducing complexity of the terminal device. In addition, differentiated model parameters, for example, different counter configurations or timer configurations, are help to avoid a problem that some beams are not monitored because a reference signal set configured for measurement is not representative, or a problem that not very poor link quality is misjudged as a link failure of a cell.

The foregoing describes method embodiments of this application in detail with reference to FIG. 5 to FIG. 6. The following describes apparatus embodiments of this application in detail with reference to FIG. 7 to FIG. 12. It should be understood that the apparatus embodiments are corresponding to the method embodiments. For similar descriptions, refer to the method embodiments.

FIG. 7 is a schematic block diagram of a terminal device 400 according to an embodiment of this application. As shown in FIG. 7, the terminal device 400 includes:
a processing unit 410, configured to perform radio link monitoring RLM and beam detection according to a first measurement model, where the beam detection includes beam failure detection BFD and candidate beam detection CBD.

In some embodiments, the processing unit 410 is further configured to: perform RLM according to the first measurement model and a first model parameter, and perform beam detection according to the first measurement model and a second model parameter, where
the first model parameter is at least partially different from the second model parameter.

In some embodiments, the first model parameter includes at least one of the following: first measurement evaluation time information, a first reference signal configuration, a first filter configuration, a first timer configuration, a first counter configuration, a first reporting time interval, or a first threshold configuration; and
the second model parameter includes at least one of the following: second measurement evaluation time information, a second reference signal configuration, a second filter configuration, a second timer configuration, a second counter configuration, a second reporting time interval, or a second threshold configuration.

In some embodiments, the first reference signal configuration is different from the second reference signal configuration; and/or
the first filter configuration is different from the second filter configuration; and/or the first timer configuration is different from the second timer configuration; and/or the first counter configuration is different from the second counter configuration; and/or the first reporting time interval is different from the second reporting time interval; and/or a first threshold configuration is different from a second threshold configuration.

In some embodiments, the first measurement evaluation time information is used to configure a time for which the terminal device performs measurement evaluation on a reference signal used for RLM;
the first reference signal configuration is used to configure the reference signal for performing RLM by the terminal device;
the first filter configuration is used to configure a parameter for filtering a measurement result of RLM by the terminal device;
the first timer configuration is used to configure a timing threshold for triggering radio link failure RLF by the terminal device;
the first counter configuration is used to configure a count value threshold for triggering RLF by the terminal device;
the first reporting time interval is used to configure a minimum time interval at which a physical layer of the terminal device reports a layer 1 indication to a higher layer of the terminal device; and
the first threshold configuration is used to configure a determining threshold for reporting the layer 1 indication by the physical layer of the terminal device to the higher layer of the terminal device.

In some embodiments, the second measurement evaluation time information is used to configure a time for which the terminal device performs measurement evaluation on a reference signal used for beam detection;
the second reference signal configuration is used to configure a reference signal for performing BFD by the terminal device;
the second filter configuration is used to configure a parameter for filtering a measurement result of BFD by the terminal device;
the second timer configuration is used to configure a timing threshold for triggering beam failure recovery BFR by the terminal device;
the second counter configuration is used to configure a count value threshold for triggering BFR by the terminal device;
the second reporting time interval is used to configure a minimum time interval at which a physical layer of the terminal device reports a beam failure instance BFI to a higher layer of the terminal device; and
the second threshold configuration is used to configure a determining threshold of the BFI and/or a determining threshold of a new beam.

In some embodiments, the first measurement evaluation time information is the same as the second measurement evaluation time information.

In some embodiments, the first measurement evaluation time information is a sum of first duration information and second duration information, where the first duration information is a measurement evaluation time for which the terminal device performs BFD, and the second duration information is a measurement evaluation time for which the terminal device performs CBD.

In some embodiments, the first measurement evaluation time information is determined according to the following formula:

$${T}_{Evaluate \_ RLM} = MAX ( X , M 1 * {K}_{BFD} * N 1 * {T}_{BFD \_ RS} ) + MAX ( Y , M 2 * {K}_{CBD} * N 2 * {T}_{CBD\_RS} ) ,$$

where T_{Evaluate_RLM} represents the first measurement evaluation time information, X represents a measurement evaluation time threshold corresponding to BFD, M1 represents a quantity of measurement samples corresponding to BFD, K_{BFD} represents a scaling factor corresponding to BFD, N1 represents a quantity of reference signals or beams configured for BFD, T_{BFD_RS} represents a reference signal period used for BFD, Y represents a measurement evaluation time threshold corresponding to CBD, M2 represents a quantity of measurement samples corresponding to CBD, K_{CBD} represents a scaling factor corresponding to CBD, N2 represents a quantity of reference signals or beams configured for CBD, and T_{CBD_RS} represents a reference signal period used for CBD.

In some embodiments, the second measurement evaluation time information includes first duration information and second duration information, where the first duration information is a measurement evaluation time for which the terminal device performs BFD, and the second duration information is a measurement evaluation time for which the terminal device performs CBD.

In some embodiments, the first duration information is determined according to the following formula:

$${T}_{Evaluate \_ BFD} = MAX ( X , M 1 * {K}_{BFD} * N 1 * {T}_{BFD \_ RS} ) ,$$

where T_{Evaluate_BFD} represents the first duration information, X represents a measurement evaluation time threshold corresponding to BFD, M1 represents a quantity of measurement samples corresponding to BFD, K_{BFD} represents a scaling factor corresponding to BFD, N1 represents a quantity of reference signals or beams configured for BFD, and T_{BFD_RS} represents a reference signal period used for BFD.

In some embodiments, the second duration information is determined according to the following formula:

$${T}_{Evaluate \_ CBD} = MAX ( X , M 2 * {K}_{CBD} * N 1 * {T}_{CBD \_ RS} ) ,$$

where T_{Evaluate_BD} represents the second duration information, Y represents a measurement evaluation time threshold corresponding to CBD, M2 represents a quantity of measurement samples corresponding to CBD, K_{CBD} represents a scaling factor corresponding to CBD, N2 represents a quantity of reference signals or beams configured for CBD, and T_{CBD_RS} represents a reference signal period used for CBD.

In some embodiments, the processing unit 410 is further configured to: perform RLM according to the first measurement model and a third model parameter; and perform beam detection according to the first measurement model and the third model parameter.

In some embodiments, the third model parameter includes at least one of the following: third measurement evaluation time information, a third reference signal configuration, a third filter configuration, a third timer configuration, a third counter configuration, a third reporting time interval, or a third threshold configuration.

In some embodiments, the third measurement evaluation time information is used to configure a time for which the terminal device performs measurement evaluation on a reference signal used for RLM and beam detection;
a reference signal configured by the third reference signal configuration is used by the terminal device to perform RLM, BFD, and CBD;
a filtering parameter configured by the third filter configuration is used by the terminal device to filter a measurement result of RLM, a measurement result of BFD, and a measurement result of CBD;
a timing threshold configured by the third timer configuration is used by the terminal device to trigger RLF and BFR;
a count value threshold configured by the third counter configuration is used by the terminal device to trigger RLF and BFR;
a time interval threshold configured by the third reporting time interval is used by a physical layer of the terminal device to report a layer 1 indication for RLM and a layer 1 indication for BFD; and
a threshold configured by the third threshold configuration is used by the physical layer of the terminal device to determine whether to report the layer 1 indication for RLM and the layer 1 indication for BFD.

In some embodiments, the third measurement evaluation time information is determined according to a sum of first duration information and second duration information, where the first duration information is a measurement evaluation time for which the terminal device performs BFD, and the second duration information is a measurement evaluation time for which the terminal device performs CBD.

In some embodiments, the third measurement evaluation time information is determined according to the following formula:

$${T}_{Evaluate \_ RLM} = MAX ( X , M 1 * {K}_{BFD} * N 1 * {T}_{BFD \_ RS} ) + MAX ( Y , M 2 * {K}_{CBD} * N 2 * {T}_{CBD\_RS} ) ,$$

where T_{Evaluate_RLM} represents the third measurement evaluation time information, X represents a measurement evaluation time threshold corresponding to BFD, M1 represents a quantity of measurement samples corresponding to BFD, K_{BFD} represents a scaling factor corresponding to BFD, N1 represents a quantity of reference signals or beams configured for BFD, T_{BFD_RS} represents a reference signal period used for BFD, Y represents a measurement evaluation time threshold corresponding to CBD, M2 represents a quantity of measurement samples corresponding to CBD, K_{CBD} represents a scaling factor corresponding to CBD, N2 represents a quantity of reference signals or beams configured for CBD, and T_{CBD_RS} represents a reference signal period used for CBD.

In some embodiments, X is determined according to a capability of the terminal device.

In some embodiments, X is 50 milliseconds.

In some embodiments, Y is determined according to a capability of the terminal device.

In some embodiments, Y is 25 milliseconds.

In some embodiments, the terminal device 400 further includes: a communication unit, configured to receive first configuration information sent by a network device, where the first configuration information is used to configure the first measurement model and/or a model parameter of the first measurement model.

In some embodiments, the terminal device further includes: a communication unit, configured to report capability information of the terminal device to a network device, where the capability information of the terminal device is used by the network device to determine a model parameter of the first measurement model.

Optionally, in some embodiments, the foregoing communication unit may be a communication interface or a transceiver, or an input/output interface of a communication chip or a system-on-chip. The foregoing processing unit may be one or more processors.

It should be understood that the terminal device 400 according to embodiments of this application may be corresponding to the terminal device in the method embodiments of this application, and the foregoing and other operations and/or functions of the units in the terminal device 400 are respectively used to implement a corresponding procedure of the terminal device in the method 300 shown in FIG. 5 to FIG. 6. For brevity, details are not described herein again.

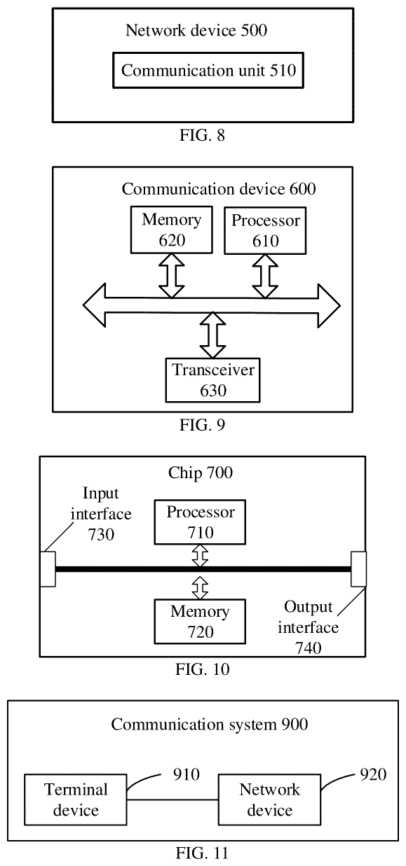

FIG. 8 is a schematic block diagram of a network device according to an embodiment of this application. The network device 500 in FIG. 8 includes:
a communication unit 510, configured to transmit first configuration information to a terminal device, where the first configuration information is used to configure a first measurement model and/or a model parameter of the first measurement model, the first measurement model is used by the terminal device to perform radio link monitoring RLM and beam detection, and the beam detection includes beam failure detection BFD and candidate beam detection CBD.

In some embodiments, the model parameter of the first measurement model includes a first model parameter and a second model parameter, the first model parameter is used for RLM, the second model parameter is used for beam detection, and the first model parameter is at least partially different from the second model parameter.

In some embodiments, the first model parameter includes at least one of the following: first measurement evaluation time information, a first reference signal configuration, a first filter configuration, a first timer configuration, a first counter configuration, a first reporting time interval, or a first threshold configuration.

The second model parameter includes at least one of the following: second measurement evaluation time information, a second reference signal configuration, a second filter configuration, a second timer configuration, a second counter configuration, a second reporting time interval, or a second threshold configuration.

In some embodiments, the first reference signal configuration is different from the second reference signal configuration; and/or
the first filter configuration is different from the second filter configuration; and/or the first timer configuration is different from the second timer configuration; and/or the first counter configuration is different from the second counter configuration; and/or the first reporting time interval is different from the second reporting time interval; and/or a first threshold configuration is different from a second threshold configuration.

In some embodiments, the first measurement evaluation time information is used to configure a time for which the terminal device performs measurement evaluation on a reference signal used for RLM;
the first reference signal configuration is used to configure the reference signal for performing RLM by the terminal device.
the first filter configuration is used to configure a parameter for filtering a measurement result of RLM by the terminal device;
the first timer configuration is used to configure a timing threshold for triggering radio link failure RLF by the terminal device.
the first counter configuration is used to configure a count value threshold for triggering RLF by the terminal device.
the first reporting time interval is used to configure a minimum time interval at which a physical layer of the terminal device reports a layer 1 indication to a higher layer of the terminal device.
the first threshold configuration is used to configure a determining threshold for reporting the layer 1 indication by the physical layer of the terminal device to the higher layer of the terminal device.

In some embodiments, the second measurement evaluation time information is used to configure a time for which the terminal device performs measurement evaluation on a reference signal used for beam detection;
the second reference signal configuration is used to configure a reference signal for performing BFD by the terminal device.
the second filter configuration is used to configure a parameter for filtering a measurement result of BFD by the terminal device.
the second timer configuration is used to configure a timing threshold for triggering beam failure recovery BFR by the terminal device.
the second counter configuration is used to configure a count value threshold for triggering BFR by the terminal device.
the second reporting time interval is used to configure a minimum time interval at which a physical layer of the terminal device reports a beam failure instance BFI to a higher layer of the terminal device.
the second threshold configuration is used to configure a determining threshold of the BFI and/or a determining threshold of a new beam.

In some embodiments, the first measurement evaluation time information is the same as the second measurement evaluation time information.

In some embodiments, the first measurement evaluation time information is a sum of first duration information and second duration information, where the first duration information is a measurement evaluation time for which the terminal device performs BFD, and the second duration information is a measurement evaluation time for which the terminal device performs CBD.

In some embodiments, the first measurement evaluation time information is determined according to the following formula:

$${T}_{Evaluate \_ RLM} = MAX ( X , M 1 * {K}_{BFD} * N 1 * {T}_{BFD \_ RS} ) + MAX ( Y , M 2 * {K}_{CBD} * N 2 * {T}_{CBD\_RS} ) ,$$

where T_{Evaluate_RLM} represents the first measurement evaluation time information, X represents a measurement evaluation time threshold corresponding to BFD, M1 represents a quantity of measurement samples corresponding to BFD, K_{BFD} represents a scaling factor corresponding to BFD, N1 represents a quantity of reference signals or beams configured for BFD, T_{BFD_RS} represents a reference signal period used for BFD, Y represents a measurement evaluation time threshold corresponding to CBD, M2 represents a quantity of measurement samples corresponding to CBD, K_{CBD} represents a scaling factor corresponding to CBD, N2 represents a quantity of reference signals or beams configured for CBD, and T_{CBD_RS} represents a reference signal period used for CBD.

In some embodiments, the second measurement evaluation time information includes first duration information and second duration information, where the first duration information is a measurement evaluation time for which the terminal device performs BFD, and the second duration information is a measurement evaluation time for which the terminal device performs CBD.

In some embodiments, the first duration information is determined according to the following formula:

$${T}_{Evaluate \_ BFD} = MAX ( X , M 1 * {K}_{BFD} * N 1 * {T}_{BFD \_ RS} ) ,$$

where T_{Evaluate_BFD} represents the first duration information, X represents a measurement evaluation time threshold corresponding to BFD, M1 represents a quantity of measurement samples corresponding to BFD, K_{BFD} represents a scaling factor corresponding to BFD, N1 represents a quantity of reference signals or beams configured for BFD, and T_{BFD_RS} represents a reference signal period used for BFD.

In some embodiments, the second duration information is determined according to the following formula:

$${T}_{Evaluate \_ CBD} = MAX ( X , M 2 * {K}_{CBD} * N 1 * {T}_{CBD \_ RS} ) ,$$

where T_{Evaluate_BD} represents the second duration information, Y represents a measurement evaluation time threshold corresponding to CBD, M2 represents a quantity of measurement samples corresponding to CBD, K_{CBD} represents a scaling factor corresponding to CBD, N2 represents a quantity of reference signals or beams configured for CBD, and T_{CBD_RS} represents a reference signal period used for CBD.

In some embodiments, the model parameter of the first measurement model includes a third model parameter, and the third model parameter is used for RLM and beam detection.

In some embodiments, the third model parameter includes at least one of the following: third measurement evaluation time information, a third reference signal configuration, a third filter configuration, a third timer configuration, a third counter configuration, a third reporting time interval, or a third threshold configuration.

In some embodiments, the third measurement evaluation time information is used to configure a time for which the terminal device performs measurement evaluation on a reference signal used for RLM and beam detection;
a reference signal configured by the third reference signal configuration is used by the terminal device to perform RLM, BFD, and CBD.
a filtering parameter configured by the third filter configuration is used by the terminal device to filter a measurement result of RLM, a measurement result of BFD, and a measurement result of CBD.
a timing threshold configured by the third timer configuration is used by the terminal device to trigger RLF and BFR.
a count value threshold configured by the third counter configuration is used by the terminal device to trigger RLF and BFR.
a time interval threshold configured by the third reporting time interval is used by a physical layer of the terminal device to report a layer 1 indication for RLM and a layer 1 indication for BFD.
a threshold configured by the third threshold configuration is used by the physical layer of the terminal device to determine whether to report the layer 1 indication for RLM and the layer 1 indication for BFD.

In some embodiments, the third measurement evaluation time information is determined according to a sum of first duration information and second duration information, where the first duration information is a measurement evaluation time for which the terminal device performs BFD, and the second duration information is a measurement evaluation time for which the terminal device performs CBD.

In some embodiments, the third measurement evaluation time information is determined according to the following formula:

$${T}_{Evaluate \_ RLM} = MAX ( X , M 1 * {K}_{BFD} * N 1 * {T}_{BFD \_ RS} ) + MAX ( Y , M 2 * {K}_{CBD} * N 2 * {T}_{CBD\_RS} ) ,$$

where T_{Evaluate_RLM} represents the third measurement evaluation time information, X represents a measurement evaluation time threshold corresponding to BFD, M1 represents a quantity of measurement samples corresponding to BFD, K_{BFD} represents a scaling factor corresponding to BFD, N1 represents a quantity of reference signals or beams configured for BFD, T_{BFD_RS} represents a reference signal period used for BFD, Y represents a measurement evaluation time threshold corresponding to CBD, M2 represents a quantity of measurement samples corresponding to CBD, K_{CBD}) represents a scaling factor corresponding to CBD, N2 represents a quantity of reference signals or beams configured for CBD, and T_{CBD_RS} represents a reference signal period used for CBD.

In some embodiments, X is determined according to a capability of the terminal device.

In some embodiments, X is 50 milliseconds.

In some embodiments, Y is determined according to a capability of the terminal device.

In some embodiments, Y is 25 milliseconds.

In some embodiments, the communication unit 510 is further configured to receive capability information of the terminal device reported by the terminal device, where the capability information of the terminal device is used by the network device to determine a model parameter of the first measurement model.

Optionally, in some embodiments, the foregoing communication unit may be a communication interface or a transceiver, or an input/output interface of a communication chip or a system-on-chip. The foregoing processing unit may be one or more processors.

It should be understood that the network device 500 according to embodiments of this application may be corresponding to the network device in the method embodiments of this application, and the foregoing and other operations and/or functions of the units in the network device 500 are respectively used to implement a corresponding procedure of the network device in the method 300 shown in FIG. 5 to FIG. 6. For brevity, details are not described herein again.

FIG. 9 is a schematic structural diagram of a communication device 600 provided by an embodiment of this application. The communication device 600 shown in FIG. 9 includes a processor 610, and the processor 610 may invoke a computer program from a memory and run the computer program to implement a method in embodiments of this application.

Optionally, as shown in FIG. 9, the communication device 600 may further include a memory 620. The processor 610 may invoke a computer program from the memory 620 and run the computer program to implement a method in embodiments of this application.

The memory 620 may be a separate component independent of the processor 610, or may be integrated into the processor 610.

In some embodiments, as shown in FIG. 10, the communication device 600 may further include a transceiver 630. The processor 610 may control the transceiver 630 to communicate with another device, and specifically, may transmit information or data to the another device, or receive information or data transmitted by the another device.

The transceiver 630 may include a transmitter and a receiver. The transceiver 630 may further include an antenna, and there may be one or more antennas.

Optionally, the communication device 600 may be the network device in embodiments of this application, and the communication device 600 may implement a corresponding procedure implemented by the network device in the methods in embodiments of this application. For brevity, details are not described herein again.

Optionally, the communication device 600 may be the mobile terminal/terminal device in embodiments of this application, and the communication device 600 may implement a corresponding procedure implemented by the mobile terminal/terminal device in the methods in embodiments of this application. For brevity, details are not described herein again.

FIG. 10 is a schematic diagram of a structure of a chip according to an embodiment of this application. The chip 700 shown in FIG. 10 includes a processor 710, and the processor 710 may invoke a computer program from a memory and run the computer program to implement a method in embodiments of this application.

Optionally, as shown in FIG. 10, the chip 700 may further include a memory 720. The processor 710 may invoke a computer program from the memory 720 and run the computer program to implement a method in embodiments of this application.

The memory 720 may be a separate component independent of the processor 710, or may be integrated into the processor 710.

Optionally, the chip 700 may further include an input interface 730. The processor 710 may control the input interface 730 to communicate with another device or chip, and specifically, may obtain information or data transmitted by the another device or chip.

Optionally, the chip 700 may further include an output interface 740. The processor 710 may control the output interface 740 to communicate with another device or chip, and specifically, may output information or data to the another device or chip.

Optionally, the chip may be applied to the network device in embodiments of this application, and the chip may implement a corresponding procedure implemented by the network device in the methods in embodiments of this application. For brevity, details are not described herein again.

Optionally, the chip may be applied to the mobile terminal/terminal device in embodiments of this application, and the chip may implement a corresponding procedure implemented by the mobile terminal/terminal device in the methods in embodiments of this application. For brevity, details are not described herein again.

It should be understood that the chip mentioned in this embodiment of this application may also be referred to as a system-level chip, a system chip, a chip system, or a system-on-chip.

FIG. 11 is a schematic block diagram of a communications system 900 according to an embodiment of this application. As shown in FIG. 11, the communications system 900 includes a terminal device 910 and a network device 920.

The terminal device 910 may be used to implement the corresponding functions implemented by the terminal device in the foregoing methods, and the network device 920 may be used to implement the corresponding functions implemented by the network device in the foregoing methods. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor can implement or perform the methods, steps and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that, the memory in the systems and methods described in this specification includes but is not limited to these memories and any memory of another proper type.

It should be understood that, by way of example but not limitative description, for example, the memory in this embodiment of this application may alternatively be a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), a direct rambus random access memory (DR RAM), or the like. In other words, the memory in this embodiment of this application includes but is not limited to these memories and any memory of another proper type.

An embodiment of this application further provides a computer-readable storage medium, configured to store a computer program.

Optionally, the computer-readable storage medium may be applied to a network device in embodiments of this application, and the computer program causes a computer to execute a corresponding procedure implemented by the network device in the methods in embodiments of this application. For brevity, details are not described herein again.

Optionally, the computer-readable storage medium may be applied to a mobile terminal/terminal device in embodiments of this application, and the computer program causes a computer to execute a corresponding procedure implemented by the mobile terminal/terminal device in the methods in embodiments of this application. For brevity, details are not described herein again.

An embodiment of this application further provides a computer program product, including computer program instructions.

Optionally, the computer program product may be applied to a network device in embodiments of this application, and the computer program instructions cause a computer to execute a corresponding procedure implemented by the network device in the methods in embodiments of this application. For brevity, details are not described herein again.

Optionally, the computer program product may be applied to a mobile terminal/terminal device in embodiments of this application, and the computer program instructions cause a computer to execute a corresponding procedure implemented by the mobile terminal/terminal device in the methods in embodiments of this application. For brevity, details are not described herein again.

An embodiment of this application further provides a computer program.

Optionally, the computer program may be applied to a network device in embodiments of this application. When the computer program runs on a computer, the computer executes a corresponding procedure implemented by the network device in the methods in embodiments of this application. For brevity, details are not described herein again.

Optionally, the computer program may be applied to a mobile terminal/terminal device in embodiments of this application. When the computer program runs on a computer, the computer executes a corresponding procedure implemented by the mobile terminal/terminal device in the methods in embodiments of this application. For brevity, details are not described herein again.

A person of ordinary skill in the art may be aware that, units and algorithm steps in examples described in embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

Those skilled in the art that may clearly understand that, for the purpose of convenient and brief description, for detailed working processes of the foregoing system, apparatus, and unit, reference may be made to a corresponding procedure in the foregoing method embodiments, and details are not described herein again.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of the embodiments.

In addition, function units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions in embodiments of this application essentially, or the part contributing to the prior art, or some of the technical solutions may be implemented in a form of a software product. The computer software product is stored in a storage medium and includes several instructions for instructing a computer device (which may be a personal computer, a server, a network device, or the like) to execute all or some of the steps of the methods in embodiments of this application. The foregoing storage medium includes various media that may store a program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A wireless communication method, comprising:
performing, by a terminal device, radio link monitoring (RLM) and beam detection according to a first measurement model, wherein the beam detection comprises beam failure detection (BFD) and candidate beam detection (CBD).

2. The method according to claim 1, wherein the performing, by a terminal device, radio link monitoring (RLM) and beam detection according to a first measurement model comprises:
performing RLM according to the first measurement model and a first model parameter; and
performing beam detection according to the first measurement model and a second model parameter, wherein
the first model parameter is at least partially different from the second model parameter.

3. The method according to claim 2, wherein the first model parameter comprises at least one of following: first measurement evaluation time information, a first reference signal configuration, a first filter configuration, a first timer configuration, a first counter configuration, a first reporting time interval, or a first threshold configuration; and
the second model parameter comprises at least one of following: second measurement evaluation time information, a second reference signal configuration, a second filter configuration, a second timer configuration, a second counter configuration, a second reporting time interval, or a second threshold configuration.

4. The method according to claim 3, wherein the first reference signal configuration is different from the second reference signal configuration; and/or
the first filter configuration is different from the second filter configuration; and/or
the first timer configuration is different from the second timer configuration; and/or
the first counter configuration is different from the second counter configuration; and/or
the first reporting time interval is different from the second reporting time interval; and/or
the first threshold configuration is different from a second threshold configuration.

5. The method according to claim 3, wherein the first measurement evaluation time information is used to configure a time for which the terminal device performs measurement evaluation on a reference signal used for RLM;
the first reference signal configuration is used to configure the reference signal for performing RLM by the terminal device;
the first filter configuration is used to configure a parameter for filtering a measurement result of RLM by the terminal device;
the first timer configuration is used to configure a timing threshold for triggering radio link failure (RLF) by the terminal device;
the first counter configuration is used to configure a count value threshold for triggering RLF by the terminal device;
the first reporting time interval is used to configure a minimum time interval at which a physical layer of the terminal device reports a layer 1 indication to a higher layer of the terminal device;
the first threshold configuration is used to configure a determining threshold for reporting the layer 1 indication by the physical layer of the terminal device to the higher layer of the terminal device;
the second measurement evaluation time information is used to configure a time for which the terminal device performs measurement evaluation on a reference signal used for beam detection;
the second reference signal configuration is used to configure a reference signal for performing BFD and CBD by the terminal device;
the second filter configuration is used to configure a parameter for filtering a measurement result of BFD by the terminal device;
the second timer configuration is used to configure a timing threshold for triggering beam failure recovery (BFR) by the terminal device;
the second counter configuration is used to configure a count value threshold for triggering BFR by the terminal device;
the second reporting time interval is used to configure a minimum time interval at which a physical layer of the terminal device reports a beam failure instance (BFI) to a higher layer of the terminal device; and
the second threshold configuration is used to configure a determining threshold of the BFI and/or a determining threshold of a new beam.

6. The method according to claim 3, wherein the first measurement evaluation time information is the same as the second measurement evaluation time information, or
wherein the first measurement evaluation time information is a sum of first duration information and second duration information, wherein the first duration information is a measurement evaluation time for which the terminal device performs BFD, and the second duration information is a measurement evaluation time for which the terminal device performs CBD.

7. The method according to claim 6, wherein the second measurement evaluation time information comprises first duration information and second duration information, wherein the first duration information is a measurement evaluation time for which the terminal device performs BFD, and the second duration information is a measurement evaluation time for which the terminal device performs CBD.

8. The method according to claim 1, wherein the performing, by a terminal device, radio link monitoring (RLM) and beam detection according to a first measurement model comprises:
performing RLM according to the first measurement model and a third model parameter; and
performing beam detection according to the first measurement model and the third model parameter.

9. The method according to claim 8, wherein the third model parameter comprises at least one of following: third measurement evaluation time information, a third reference signal configuration, a third filter configuration, a third timer configuration, a third counter configuration, a third reporting time interval, or a third threshold configuration.

10. The method according to claim 9, wherein
the third measurement evaluation time information is used to configure a time for which the terminal device performs measurement evaluation on a reference signal used for RLM and beam detection;
a reference signal configured by the third reference signal configuration is used by the terminal device to perform RLM, BFD, and CBD;
a filtering parameter configured by the third filter configuration is used by the terminal device to filter a measurement result of RLM, a measurement result of BFD, and a measurement result of CBD;
a timing threshold configured by the third timer configuration is used by the terminal device to trigger RLF and BFR;
a count value threshold configured by the third counter configuration is used by the terminal device to trigger RLF and BFR;
a time interval threshold configured by the third reporting time interval is used by a physical layer of the terminal device to report a layer 1 indication for RLM and a layer 1 indication for BFD; and
a threshold configured by the third threshold configuration is used by the physical layer of the terminal device to determine whether to report the layer 1 indication for RLM and the layer 1 indication for BFD.

11. The method according to claim 9, wherein the third measurement evaluation time information is determined according to a sum of first duration information and second duration information, wherein the first duration information is a measurement evaluation time for which the terminal device performs BFD, and the second duration information is a measurement evaluation time for which the terminal device performs CBD.

12. The method according to claim 1, wherein the method further comprises:
receiving, by the terminal device, first configuration information sent by a network device, wherein the first configuration information is used to configure the first measurement model and/or a model parameter of the first measurement model.

13. The method according to claim 1, wherein the method further comprises:
reporting, by the terminal device, capability information of the terminal device to a network device, wherein the capability information of the terminal device is used by the network device to determine a model parameter of the first measurement model.

14. A terminal device, comprising a processor and a memory, wherein the memory is configured to store a computer program, and the processor is configured to invoke and run the computer program stored in the memory to execute the method according to claim 1.

15. A network device, comprising:
a processor and a memory, wherein the memory is configured to store a computer program, and the processor is configured to invoke and run the computer program stored in the memory to cause the network device to perform:
transmitting, first configuration information to a terminal device, wherein the first configuration information is used to configure a first measurement model and/or a model parameter of the first measurement model, the first measurement model is used by the terminal device to perform radio link monitoring (RLM) and beam detection, and the beam detection comprises beam failure detection (BFD) and candidate beam detection (CBD).

16. The network device according to claim 15, wherein the model parameter of the first measurement model comprises a first model parameter and a second model parameter, the first model parameter is used for RLM, the second model parameter is used for beam detection, and the first model parameter is at least partially different from the second model parameter.

17. The network device according to claim 16, wherein the first model parameter comprises at least one of following: first measurement evaluation time information, a first reference signal configuration, a first filter configuration, a first timer configuration, a first counter configuration, a first reporting time interval, or a first threshold configuration; and
the second model parameter comprises at least one of following: second measurement evaluation time information, a second reference signal configuration, a second filter configuration, a second timer configuration, a second counter configuration, a second reporting time interval, or a second threshold configuration.

18. The network device according to claim 17, wherein the first reference signal configuration is different from the second reference signal configuration; and/or
the first filter configuration is different from the second filter configuration; and/or
the first timer configuration is different from the second timer configuration; and/or
the first counter configuration is different from the second counter configuration; and/or
the first reporting time interval is different from the second reporting time interval; and/or
the first threshold configuration is different from a second threshold configuration.

19. The network device according to claim 17, wherein
the first measurement evaluation time information is used to configure a time for which the terminal device performs measurement evaluation on a reference signal used for RLM;
the first reference signal configuration is used to configure the reference signal for performing RLM by the terminal device;
the first filter configuration is used to configure a parameter for filtering a measurement result of RLM by the terminal device;
the first timer configuration is used to configure a timing threshold for triggering radio link failure (RLF) by the terminal device;
the first counter configuration is used to configure a count value threshold for triggering RLF by the terminal device;
the first reporting time interval is used to configure a minimum time interval at which a physical layer of the terminal device reports a layer 1 indication to a higher layer of the terminal device; and
the first threshold configuration is used to configure a determining threshold for reporting the layer 1 indication by the physical layer of the terminal device to the higher layer of the terminal device.

20. The network device according to claim 17, wherein
the second measurement evaluation time information is used to configure a time for which the terminal device performs measurement evaluation on a reference signal used for beam detection;
the second reference signal configuration is used to configure a reference signal for performing BFD and CBD by the terminal device;
the second filter configuration is used to configure a parameter for filtering a measurement result of BFD by the terminal device;
the second timer configuration is used to configure a timing threshold for triggering beam failure recovery (BFR) by the terminal device;
the second counter configuration is used to configure a count value threshold for triggering BFR by the terminal device;
the second reporting time interval is used to configure a minimum time interval at which a physical layer of the terminal device reports a beam failure instance (BFI) to a higher layer of the terminal device; and
the second threshold configuration is used to configure a determining threshold of the BFI and/or a determining threshold of a new beam.
